(19) United States
(12) Patent Application Publication
(10) Pub. No.: US 2020/0376584 A1
(43) Pub. Date: Dec. 3, 2020

(54) INTEGRATED WELD POSITION DETECTION DEVICE BASED ON BINAURAL EFFECT

(71) Applicant: NANCHANG HANGKONG UNIVERSITY, Nanchang City (CN)

(72) Inventors: Yanfeng Gao, Nanchang City (CN); Yanfeng Gong, Nanchang City (CN); Jianhua Xiao, Nanchang City (CN)

(73) Assignee: NANCHANG HANGKONG UNIVERSITY

(21) Appl. No.: 16/842,598

(22) Filed: Apr. 7, 2020

(30) Foreign Application Priority Data
May 27, 2019 (CN) 201910445587.X

(51) Int. Cl. B23K 9/127; G01S 15/06; B23K 9/095

(52) U.S. Cl. CPC B23K 9/1276; B23K 9/28; B23K 9/0956; G01S 15/06

(57) ABSTRACT

The present disclosure discloses an integrated weld position detection device based a binaural effect, including a microphone, a microphone holder, a megaphone, a conductive rod, and a current contact nozzle, where the microphone holder is provided with a first through hole in the center; the first through hole allows the conductive rod to pass through and is fixedly connected to the conductive rod; the current contact nozzle is fixedly connected to the conductive rod; the microphone holder is internally provided with two accommodating cavities; the two accommodating cavities are symmetrically distributed on left and right sides of the microphone holder; two microphones are respectively disposed inside the two accommodating cavities; the megaphone is provided with at least two sound transmission channels; first ends of the two sound transmission channels communicate with the two accommodating cavities respectively.

### CROSS-REFERENCE TO RELATED PATENT APPLICATIONS

This application claims priority to Chinese Patent Application No. 201910445587.X, filed on May 27, 2019, entitled “Integrated Weld Position Detection Device Based on Binaural Effect,” which is hereby incorporated by reference in its entirety.

### TECHNICAL FIELD

The present disclosure relates to the field of arc welding, and in particular, to an integrated weld position detection device based on a binaural effect.

### BACKGROUND

With the development of machinery, power and material industries, etc., welding technology has become a very important hot metal working technology. Modern production has put forward requirements for welding technology to further improve efficiency, optimize quality, and improve working conditions, etc. Welding automation is a typical example that welding workers follow such requirements. The development and application of new welding automation technology will play a huge role in China's national economy, and an automatic weld tracking system is an important aspect of welding automation research.

At present, there is a dual microphone array welding path detection device. The dual microphone array welding path detection device is fixed on a welding workpiece, and only detects the position of the welding gun. It cannot detect the position of a groove weld. Research on the application of acoustic position discrimination technology for the detection of groove weld position is still blank.

The existing weld tracking technology mainly has the following problems: a welding torch will be caused to deviate from a weld due to strong arc radiation, high temperature, fume, splash, groove condition, machining error, clamping accuracy, surface condition, and thermal deformation of a workpiece, etc. As a result, the welding quality will be caused to decline or even fail. This change in welding conditions requires that an arc welding robot can detect a weld deviation in real time and adjust a welding path and a welding parameter to ensure the reliability of the welding quality. Therefore, the market urgently needs a weld position detection device with low cost, simple and compact structure, and good tracking accuracy.

### SUMMARY

An objective of the present invention is to provide an integrated weld position detection device based on a binaural effect, to solve the above-mentioned problems of the current technologies, to provide good weld position detection accuracy for a weld tracking process, and improve welding quality.

To achieve the above purpose, the present disclosure provides the following technical solutions.

The present disclosure provides an integrated weld position detection device based on a binaural effect, including a microphone, a microphone holder, a megaphone, a conductive rod, and a current contact nozzle, where the microphone holder is provided with a first through hole in the center; the first through hole allows the conductive rod to pass through and is fixedly connected to the conductive rod; the current contact nozzle is fixedly connected to the conductive rod; the microphone holder is internally provided with two accommodating cavities; the two accommodating cavities are symmetrically distributed on left and right sides of the microphone holder; two microphones are respectively disposed inside the two accommodating cavities, and the microphones are in electrical or communication connection with an information processing structure; the conductive rod is connected with a welding gun; the current contact nozzle is connected with a welding wire; the conductive rod has a gas guiding cavity, and a first end of the gas guiding cavity communicates with a gas outlet of the welding gun; a side wall of the conductive rod is provided with a second through hole; a first end of the current contact nozzle extends into the first through hole and is fixedly connected to the conductive rod; a second end of the current contact nozzle extends out of the first through hole, and the second end of the current contact nozzle has a welding wire socket; the megaphone is provided with a third through hole for accommodating the current contact nozzle; the megaphone is fixed on the microphone holder; the megaphone is provided with at least two sound transmission channels; first ends of the two sound transmission channels communicate with the two accommodating cavities respectively; second ends of the two sound transmission channels extend to a surface of the megaphone and locate on left and right sides of the third through hole; a protective gas in the welding gun can pass through the gas guiding cavity, the second through hole, the first through hole, and the third through hole in sequence and flow out of the megaphone.

Preferably, the microphone holder has a microphone cooling chamber.

Preferably, the microphone cooling chamber is a ring-shaped structure and surrounds an outer side of the two accommodating cavities.

Preferably, the microphone holder is provided with a water inlet and a water outlet; the water inlet and the water outlet are respectively connected to a water inlet structure and a water outlet structure.

Preferably, the water inlet structure includes a first gland and a water inlet tube, and the water outlet structure includes a second gland and a water outlet tube; the first gland and the second gland are respectively fixed to the microphone holder by a fastener; the first gland and the second gland are respectively provided with a threaded hole at a position corresponding to the water inlet and the water outlet; the water inlet tube and the water outlet tube are respectively connected with the threaded hole through a threaded tube joint.

Preferably, left and right sides inside the microphone holder are respectively provided with a resonant cavity; the resonant cavity is located between the accommodating cavity and the first end of the sound transmission channel, and the resonant cavity is a hollow cavity.

Preferably, the megaphone has a structure shaped like a circular truncated cone; a larger end of the megaphone is fixedly connected to the microphone holder.

Preferably, an inner wall of the accommodating cavity is provided with an insulating layer.

Compared with current technologies, the present disclosure achieves the following technical effects.

In the integrated weld position detection device based on a binaural effect provided by the present disclosure, an arc sound enters a corresponding resonant cavity through left and right sound transmission channels from a megaphone, and the arc sound is received by a microphone after resonance enhancement. The device provided by the present disclosure can accurately detect the position of a welding torch on a weld and a deviation thereof based on an arc sound signal acquired by left and right microphones.

Further, a microphone holder can be used to isolate other sounds from the environment, ensuring that only an arc sound is received by the microphone through the sound transmission channel.

### BRIEF DESCRIPTION OF THE DRAWINGS

To describe the technical solutions in the embodiments of the present disclosure or in the current technologies more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a sectional view of a longitudinal section of an integrated weld position detection device based on a binaural effect provided by the present disclosure;

FIG. 2 is a front view of an integrated weld position detection device based on a binaural effect provided by the present disclosure;

FIG. 3 is a side view of an integrated weld position detection device based on a binaural effect provided by the present disclosure;

FIG. 4 is a top view of an integrated weld position detection device based on a binaural effect provided by the present disclosure;

FIG. 5 is a schematic diagram showing a normal working state of an integrated weld position detection device based on a binaural effect provided by the present disclosure; and

FIG. 6 is a schematic diagram showing a deviated working state of an integrated weld position detection device based on a binaural effect provided by the present disclosure.

Where, 1. megaphone, 2. sound transmission channel, 3. resonant cavity, 4. microphone, 5. microphone holder, 6. gland, 7. conductive rod, 8. microphone cooling chamber, 9. insulating layer, and 10. current contact nozzle.

### DETAILED DESCRIPTION

The technical solutions in the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide an integrated weld position detection device based a binaural effect, to provide good weld position detection accuracy for a weld tracking process, and improve welding quality.

To make the objectives, features and advantages of the present disclosure more apparent and comprehensible, the present disclosure is described in more detail below with reference to the accompanying drawings and specific implementations.

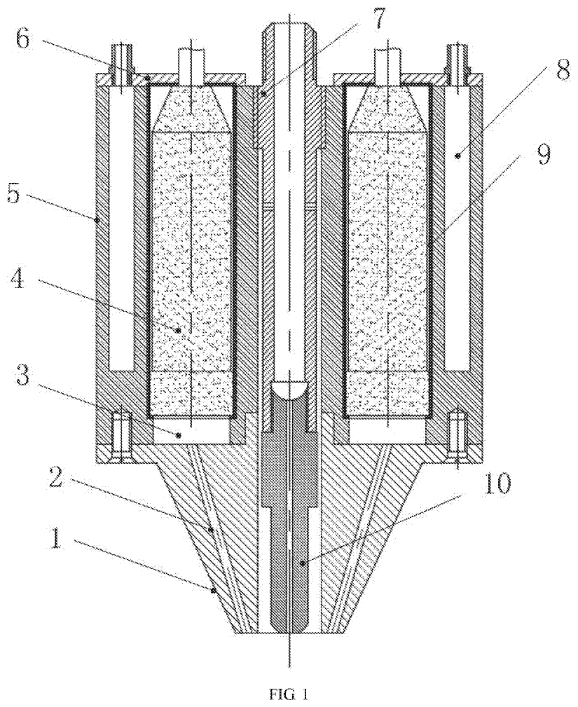

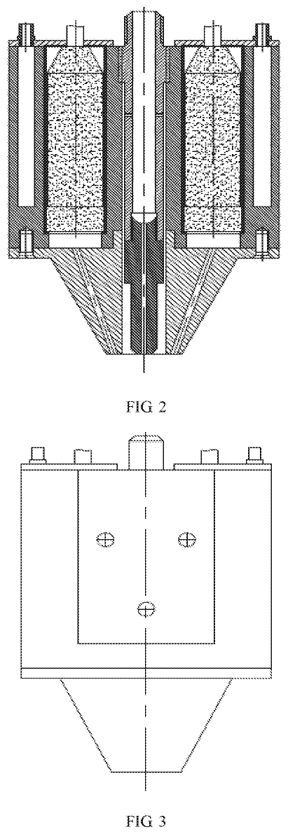

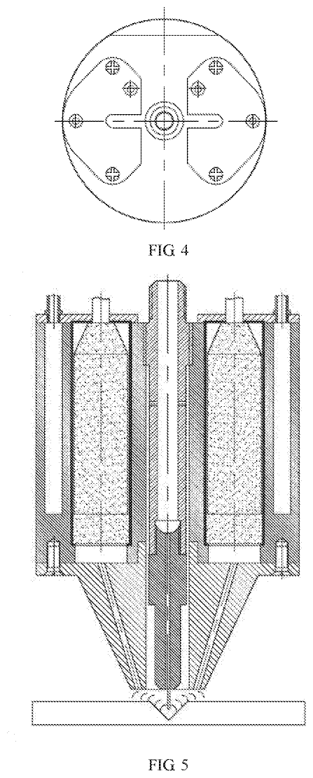

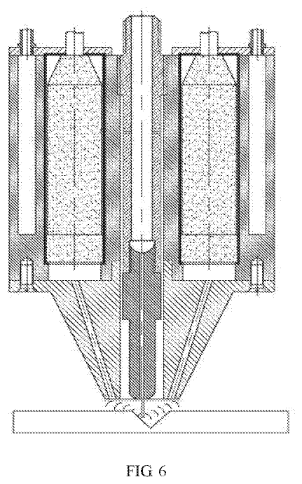

As shown in FIG. 1 to FIG. 3, the present embodiment provides an integrated weld position detection device based on a binaural effect, including a microphone 4, a microphone holder 5, a megaphone 1, a conductive rod 7, and a current contact nozzle 10. The microphone holder 5 is provided with a first through hole in the center. The first through hole allows the conductive rod 7 to pass through and is fixedly connected to the conductive rod 7. The current contact nozzle 10 is fixedly connected to the conductive rod 7. The microphone holder 5 is internally provided with two accommodating cavities. The two accommodating cavities are symmetrically distributed on left and right sides of the microphone holder 5. Two microphones 4 are respectively disposed inside the two accommodating cavities, and the microphones 4 are in electrical or communication connection with an information processing structure. The conductive rod 7 is connected with a welding gun. The current contact nozzle 10 is connected with a welding wire. The conductive rod 7 has a gas guiding cavity, and a first end of the gas guiding cavity communicates with a gas outlet of the welding gun. A side wall of the conductive rod 7 is provided with a second through hole. A first end of the current contact nozzle 10 extends into the first through hole and is fixedly connected to the conductive rod 7. A second end of the current contact nozzle 10 extends out of the first through hole, and the second end of the current contact nozzle 10 has a welding wire socket. The megaphone 1 is provided with a third through hole for accommodating the current contact nozzle 10. The megaphone 1 is fixed on the microphone holder 5. The megaphone 1 is provided with at least two sound transmission channels 2. First ends of the two sound transmission channels 2 communicate with the two accommodating cavities respectively. Second ends of the two sound transmission channels 2 extend to a surface of the megaphone 1 and locate on left and right sides of the third through hole. A protective gas in the welding gun can pass through the gas guiding cavity, the second through hole, the first through hole, and the third through hole in sequence and flow out of the megaphone 1.

When the integrated weld position detection device based on a binaural effect in this embodiment is used, a head portion of the welding gun is first removed. Then, the remaining structure of the welding gun is connected to the conductive rod 7, and the welding wire is inserted into the current contact nozzle 10. During welding, the protective gas released by the welding gun passes through the gas guiding cavity, the second through hole, the first through hole, and the third through hole in sequence and flows out of the megaphone 1 in order to isolate the air and prevent a metal from being oxidized. An arc sound is received by the microphones 4 through the left and right sound transmission channels 2 from the megaphone 1, and transmitted to the information processing structure. After calculation of the information processing structure, the position of a welding torch on a weld and a deviation thereof are detected, which is convenient for adjusting the position of the welding wire.

In this embodiment, the microphone holder 5 has a microphone cooling chamber 8 for absorbing the heat of the microphone holder 5 to achieve the effect of radiating heat and preventing a danger caused by excessive temperature.

In this embodiment, the microphone cooling chamber 8 is a ring-shaped structure and surrounds an outer side of the two accommodating cavities. In this way, the microphone cooling chamber 8 can absorb the heat in an entire circumferential direction of the microphone holder 5, so that the microphone holder 5 is better cooled down. Those skilled in the art can also set the microphone cooling chamber into a spiral structure or other shapes, as long as the microphone cooling chamber can absorb the heat of the microphone holder 5.

In this embodiment, the microphone holder 5 is provided with a water inlet and a water outlet. The water inlet and the water outlet are respectively connected to a water inlet structure and a water outlet structure, and continuous circulation of inlet water and outlet water achieves a technical effect of continuously absorbing heat.

In this embodiment, the water inlet structure includes a first gland 6 and a water inlet tube, and the water outlet structure includes a second gland 6 and a water outlet tube. The first gland 6 and the second gland 6 are respectively fixed to the microphone holder 5 by a fastener. The first gland 6 and the second gland 6 are respectively provided with a threaded hole at a position corresponding to the water inlet and the water outlet. The water inlet tube and the water outlet tube are respectively connected with the threaded hole through a threaded tube joint, which is convenient to replace a part that is damaged and cost-saving.

In this embodiment, left and right sides inside the microphone holder 5 are respectively provided with a resonant cavity 3. The resonant cavity 3 is located between the accommodating cavity and the first end of the sound transmission channel 2, and the resonant cavity 3 is a hollow cavity. The purpose of setting the resonant cavity 3 is to amplify a sound signal from the sound transmission channel 2 and make the sound signal received by the microphone 4 clearer.

In this embodiment, the megaphone 1 has a structure shaped like a circular truncated cone to save a material and reduce a machining cost. A larger end of the megaphone 1 is fixedly connected to the microphone holder 5. Those skilled in the may still use structures such as a cube and a cylinder, as long as the sound transmission channel 2 can be provided and fixed to the microphone holder 5.

In this embodiment, an inner wall of the accommodating cavity is provided with an insulating layer 9. The insulating layer 9 can effectively prevent a current in the conductive rod 7 from being conducted to the microphone 4, thereby preventing the current from affecting the microphone 4.

Specific embodiments are applied in this specification to describe the principle and implementations of the present disclosure. The description of the aforementioned embodiments is only used for facilitating understanding of the method and the core idea of the present disclosure; and meanwhile, for those of ordinary skills in the art, there will be changes in specific implementations and application scope in accordance with the concept of the present disclosure. In conclusion, the content of this specification shall not be construed as a limitation to the disclosure.

What is claimed is:

1. An integrated weld position detection device based on a binaural effect, comprising a microphone, a microphone holder, a megaphone, a conductive rod, and a current contact nozzle, wherein the microphone holder is provided with a first through hole in the center; the first through hole allows the conductive rod to pass through and is fixedly connected to the conductive rod; the current contact nozzle is fixedly connected to the conductive rod; the microphone holder is internally provided with two accommodating cavities; the two accommodating cavities are symmetrically distributed on left and right sides of the microphone holder; two microphones are respectively disposed inside the two accommodating cavities, and the microphones are in electrical or communication connection with an information processing structure; the conductive rod is connected with a welding gun; the current contact nozzle is connected with a welding wire; the conductive rod has a gas guiding cavity, and a first end of the gas guiding cavity communicates with a gas outlet of the welding gun; a side wall of the conductive rod is provided with a second through hole; a first end of the current contact nozzle extends into the first through hole and is fixedly connected to the conductive rod; a second end of the current contact nozzle extends out of the first through hole, and the second end of the current contact nozzle has a welding wire socket; the megaphone is provided with a third through hole for accommodating the current contact nozzle; the megaphone is fixed on the microphone holder; the megaphone is provided with at least two sound transmission channels; first ends of the two sound transmission channels communicate with the two accommodating cavities respectively; second ends of the two sound transmission channels extend to a surface of the megaphone and locate on left and right sides of the third through hole; a protective gas in the welding gun can pass through the gas guiding cavity, the second through hole, the first through hole, and the third through hole in sequence and flow out of the megaphone.

2. The integrated weld position detection device based on a binaural effect according to claim 1, wherein the microphone holder has a microphone cooling chamber.

3. The integrated weld position detection device based on a binaural effect according to claim 2, wherein the microphone cooling chamber is a ring-shaped structure and surrounds an outer side of the two accommodating cavities.

4. The integrated weld position detection device based on a binaural effect according to claim 3, wherein the microphone holder is provided with a water inlet and a water outlet; the water inlet and the water outlet are respectively connected to a water inlet structure and a water outlet structure.

5. The integrated weld position detection device based on a binaural effect according to claim 4, wherein the water inlet structure comprises a first gland and a water inlet tube, and the water outlet structure comprises a second gland and a water outlet tube; the first gland and the second gland are respectively fixed to the microphone holder by a fastener; the first gland and the second gland are respectively provided with a threaded hole at a position corresponding to the water inlet and the water outlet; the water inlet tube and the water outlet tube are respectively connected with the threaded hole through a threaded tube joint.

6. The integrated weld position detection device based on a binaural effect according to claim 1, wherein left and right sides inside the microphone holder are respectively provided with a resonant cavity; the resonant cavity is located between the accommodating cavity and the first end of the sound transmission channel, and the resonant cavity is a hollow cavity.

7. The integrated weld position detection device based on a binaural effect according to claim 1, wherein the megaphone has a structure shaped like a circular truncated cone; a larger end of the megaphone is fixedly connected to the microphone holder.

8. The integrated weld position detection device based on a binaural effect according to claim 1, wherein an inner wall of the accommodating cavity is provided with an insulating layer.
